(19) United States
(12) Patent Application Publication
(10) Pub. No.: US 2011/0199388 A1
(43) Pub. Date: Aug. 18, 2011

(54) METHOD AND APPARATUS FOR CONFIGURING GRAPHICAL EFFECT IN A MOBILE TERMINAL

(75) Inventors: Sung-Jae PARK, Suwon-si (KR); Seok- Jae Jeong, Suwon-si (KR); Jin-Hee Choi, Suwon-si (KR); Chun-Eon Park, Suwon-si (KR)

(73) Assignee: Samsung Electronics Co., Ltd., Suwon-si (KR)

(21) Appl. No.: 13/028,738

(22) Filed: Feb. 16, 2011

(30) Foreign Application Priority Data
Feb. 17, 2010 (KR) 10-2010-0014321
Mar. 25, 2010 (KR) 10-2010-0026857

(51) Int. Cl. G09G 5/00

(52) U.S. Cl. 345/619

(57) ABSTRACT

A method for setting a graphical effect of a mobile terminal is provided. The method includes displaying a default graphical effect module when an entry for a setting mode of a graphical effect module is requested; determining whether at least one additional graphical effect module corresponding to the default graphical effect module exists, and displaying, upon a determination that the at least one additional graphical effect module corresponding to the default graphical effect module exists, the at least one additional graphical effect module; and registering an additional graphical effect module selected from among the displayed additional graphical effect modules as a graphical effect module to be used instead of the default graphical effect module, according to a user-request.

### PRIORITY

This application claims priority under 35 U.S.C. §119(a) to applications filed in the Korean Industrial Property Office on Feb. 17, 2010 and Mar. 25, 2010, and assigned Serial Nos. 10-2010-0014321 and 10-2010-0026857, respectively, the contents of which are incorporated herein by reference.

### BACKGROUND OF THE INVENTION

1. Field of the Invention

The present invention relates generally to a mobile terminal and more particularly, to a method and an apparatus for setting a graphical effect of a mobile terminal and then applying the set graphical effect to the mobile terminal.

2. Description of the Related Art

In addition to general communication functions, many mobile terminals, such as a mobile phone, Personal Digital Assistant (PDA), an e-book reader, a smart phone, etc., generally provide various kinds of functions such as wireless Internet functions, electronic book functions, multimedia photographing/reproduction functions, game functions, etc.

A mobile terminal may notify a user of various events by displaying multiple kinds of events generated in a system based on diverse graphical effects corresponding to the generated events. For example, when performing operations such as generating and deleting a window (e.g., a display window), maximizing or minimizing a display size of a window, moving a window, etc., it may be possible to notify a user of these functions via pre-set graphical effects.

Meanwhile, since such graphical effects are set when during manufacture of a mobile terminal, a user may not be able to use the mobile terminal with other graphical effects that the user may want to use in the future. Further, the kinds of events for displaying the graphical effect are limited to generation/disappearance/movement/adjustment of a size of a window, etc. Even further, the graphical effects are respectively inter-dependent with the various kinds of generated events.

### SUMMARY OF THE INVENTION

Accordingly, the present invention has been made to solve the above-mentioned problems occurring in the prior art, and the present invention provides a method for allowing a user to easily set his desired graphical effect to an arbitrary event that the user wants to apply, and use the effect freely. The present invention also provides a method and an apparatus for allowing a graphical effect to be displayed for an event by minimizing or separating the relationships between types of events and graphical effect to be displayed.

In accordance with an aspect of the present invention, a method for setting a graphical effect of a mobile terminal is provided. The method includes displaying a default graphical effect module when an entry for a setting mode of a graphical effect module is requested; determining whether at least one additional graphical effect module corresponding to the default graphical effect module exists, and displaying, upon a determination that the at least one additional graphical effect module corresponding to the default graphical effect module exists, the at least one additional graphical effect module; and registering an additional graphical effect module selected from among the displayed additional graphical effect modules as a graphical effect module to be used instead of the default graphical effect module, according to a user-request.

In accordance with another aspect of the present invention, an apparatus for setting a graphical effect of a mobile terminal is provided. The apparatus includes a memory for storing a default graphical effect module and at least one additional graphical effect module; a control unit for displaying the default graphical effect module when an entry for a setting mode of a graphical effect module is requested; determining whether at least one additional graphical effect module corresponding to the default graphical effect module exists, and displaying, upon a determination that at least one additional graphical module corresponding to the default graphical effect module exists, the at least one additional graphical effect module corresponding to the default graphical effect modules; and registering an additional graphical effect module selected from among the displayed additional graphical effect modules as a graphical effect module to be used instead of the corresponding default graphical effect module according to a user-request; and a display unit for displaying a graphical effect according to the default graphical effect module and the at least one additional graphical effect module corresponding to the default graphical effect module.

In accordance with another aspect of the present invention, a recording medium that includes commands for enabling a mobile terminal to execute a method for setting a graphical effect and can be read by the mobile terminal is provided. The method includes displaying, when an entry for a setting mode of a graphical effect module is requested, a default graphical effect module; determining whether at least one additional graphical effect module corresponding to the default graphical effect module exists, and displaying, upon a determination that at least one additional graphical effect module corresponding to the default graphical effect module exists, the at least one additional graphical effect module; and registering an additional graphical effect module selected from among the displayed at least one additional graphical effect module as a graphical effect module to be used instead of the default graphical effect module, according to a user-request.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a mobile terminal according to an embodiment of the present invention;

FIG. 2 is a flowchart illustrating a method for setting a graphical effect of a mobile terminal according to an embodiment of the present invention; and

FIG. 3 is an exemplary diagram illustrating a method for setting a graphical effect of a mobile terminal according to an embodiment of the present invention.

### DETAILED DESCRIPTION OF EMBODIMENTS OF THE PRESENT INVENTION

Hereinafter, embodiments of the present invention are described with reference to the accompanying drawings.

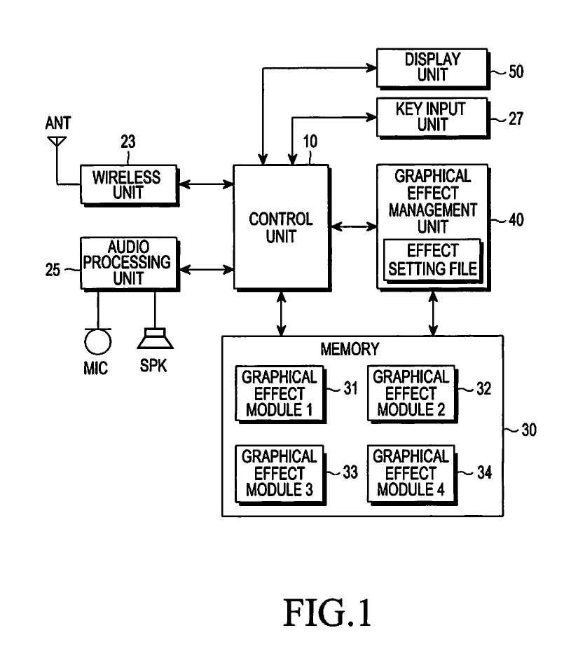

FIG. 1 is a block diagram illustrating a mobile terminal according to an embodiment of the present invention. A mobile terminal according to embodiments of the present invention refers to a terminal providing communication functions, including mobile broadcasting receivers such as a video telephone, a mobile phone, a smart phone, an International Mobile Communication 2000 (IMT-2000) terminal, a Wideband Code Division Multiple Access (WCDMA) terminal, a Universal Mobile Telecommunication Service (UMTS) terminal, a Personal Digital Assistant (PDA), a Portable Multimedia Player (PMP), a Digital Multimedia Broadcasting (DMB), etc. Further, devices such as a Personal Computer (PC), a desktop computer, a notebook, etc., may also be examples of a mobile terminal according to embodiments of the present invention.

Referring to FIG. 1, a mobile terminal according to an embodiment of the present invention includes a key input unit 27 that includes keys for entering numbers and character information and function keys for setting various kinds of functions. The key input unit 27 can receive a key input for executing an application that is driven in the mobile terminal according to key operations of a user. The key input unit 27 can also receive a key input, from a user, for controlling the application's menu.

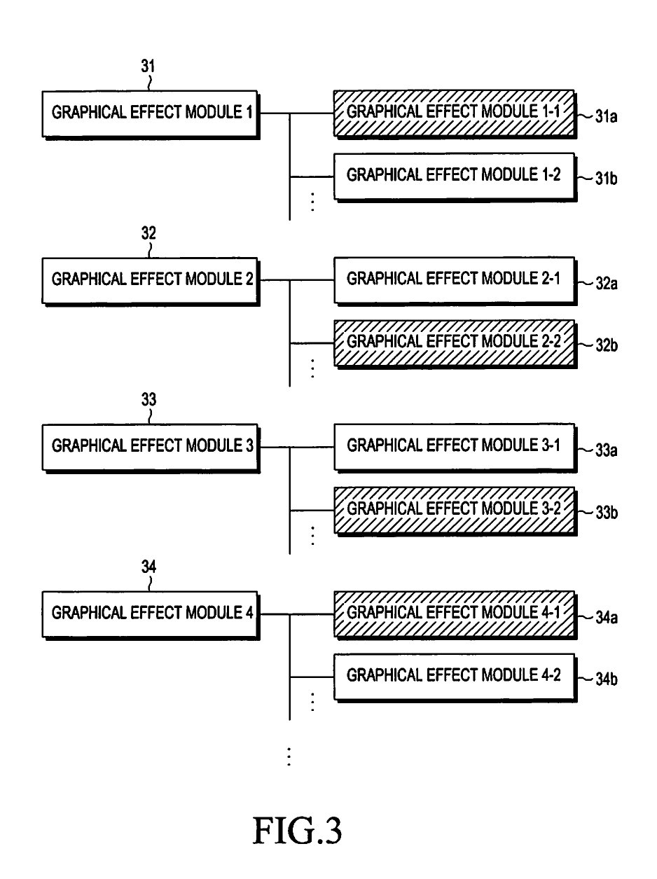

A wireless transmission/reception unit 23 executes a wireless communication function of a mobile terminal and includes a Radio Frequency (RF) unit and a MOdulator DEModulator (MODEM). The RF unit includes an RF transmitter for up-converting and amplifying a frequency of a transmitted signal, and an RF receiver for amplifying low noises of a received signal and down-converting a frequency of the received signal. The MODEM includes a transmitter for encoding and modulating a signal to be transmitted and a receiver for demodulating and decoding a signal received in the RF unit. A user can receive the graphical effect modules (31a-31b, 32a-32b, 33a-33b and 34a-34b) illustrated in FIG. 3 via a wireless communication supported by the wireless transmission/reception unit 23.

An audio processing unit 25 can configure a codec that includes a data codec and an audio codec. The data codec processes packet data and the audio codec processes audio signals such as audio signals corresponding to a multimedia file, etc. Further, the audio processing unit 25 converts a digital audio signal received in the modem into an analog signal via the audio codec, and outputs the converted analog signal. The audio processing unit 25 also converts an analog signal generated from a microphone into a digital audio signal via the audio codec, and transmits the converted digital audio signal to the modem. The codec may be included in a control unit 10 of the mobile terminal or may be separate from the control unit 10. When a predetermined event related to the operations of the mobile terminal is generated, if a visual effect (or visual information) generated due to a graphical effect module is displayed via a display unit 50, a user can identify the generated event. The audio processing unit 25 can notify a user of the generation of the event via auditory information (e.g., an execution tone and a finishing tone). As explained above, a user can identify the generated event according to the operations of the mobile terminal through the auditory information outputted via the audio processing unit 25 along with the visual information displayed in the display unit 50.

A memory 30 includes Read Only Memory (ROM) and Random Access Memory (RAM). The memory 30 can include a program memory and a data memory. The memory 30 can also store programs for controlling the operations of the mobile terminal and data for booting. The memory 30 may include graphical effect modules 1-4, which are designated by reference numerals 31-34, respectively, as illustrated in FIGS. 1 and 3. Default settings of the graphical effect modules 31 to 34 are set before final delivery of new mobile terminals, and therefore, it is possible to notify a user of the generation of an event related to the operations of the mobile terminal via visual information, and the notification function can be designated as a default graphical effect module. In addition, the memory 30 according to an embodiment of the present invention may include additional graphical effect modules, such as graphical effect module 1-1 (31a), graphical effect module 1-2 (31b), graphical effect module 2-1 (32a), graphical effect module 2-2 (32b), graphical effect module 3-1 (33a), graphical effect module 3-2 (33b), graphical effect module 4-1 (34a), and graphical effect module 4-2 (34b). The graphical effect modules 31a-31b, 32a-32b, 33a-33b, and 34a-34b, may be graphical effect modules that are received additionally through a wired communication or a wireless communication after delivery of the mobile terminal.

In connection with the graphical effects indicated by a default graphical effect module and an additional graphical module, for example, when a display window is created by driving of an application, the creation of the window may be displayed via fade in/out effects. Similarly, when a menu of a driven application is selected, the selected menu may be displayed reversely (e.g., by swapping and/or inverting color and/or brightness values of the text and background within the area of the selected menu). Fade in/out effects refer to effects where a display window of an application disappears or appears slowly in a semi-transparent manner.

FIG. 3 is a diagram illustrating a method for setting a graphical effect of a mobile terminal according to an embodiment of the present invention.

Referring to FIGS. 1 and 3, a graphical effect management unit 40 includes an effect setting file corresponding to a setting file for a graphical effect module, such as illustrated in FIG. 3. The effect setting file includes a registration file (which includes, for example, attributes of the graphical effect, an IDentification (ID), a memory address, etc.) for identifying and managing the graphical effect modules. The graphical effect management unit 40 may be included in the control unit 10.

A display unit 50 displays an image signal and user data on a screen or displays data related to a communication execution. The display unit 50 may include a Liquid Crystal Display (LCD) or an Organic Light Emitting Diode (OLED) display, etc. When the display unit 50 includes LCD or OLED is implemented with a touch screen, the display unit 50 can function as an input unit for controlling the mobile terminal while interacting with the key input unit 27. When a predetermined event related to the operations of the mobile terminal is generated, the display unit 50 displays visual information corresponding to the generated event. The displayed visual information can be implemented with the graphical effect modules according to controls of the control unit 10 and the graphical effect management unit 40.

The control unit 10 executes a function for controlling operations of the mobile terminal. The control unit 10 according to an embodiment of the present invention manages the graphical effect modules 31-34 stored in the memory 30, and the graphical effect modules 31a-31b, 32a-32b, 33a-33b and 34a-34b, which are additionally received according to interactions with the graphical effect management unit 40. When an event that has been set to be displayed via a concerned graphical effect module occurs, the control unit 10 controls a user-notification indicating the generation of the event in the form of visual information (or a visual effect) via corresponding graphical effect modules, with reference to an effect setting file.

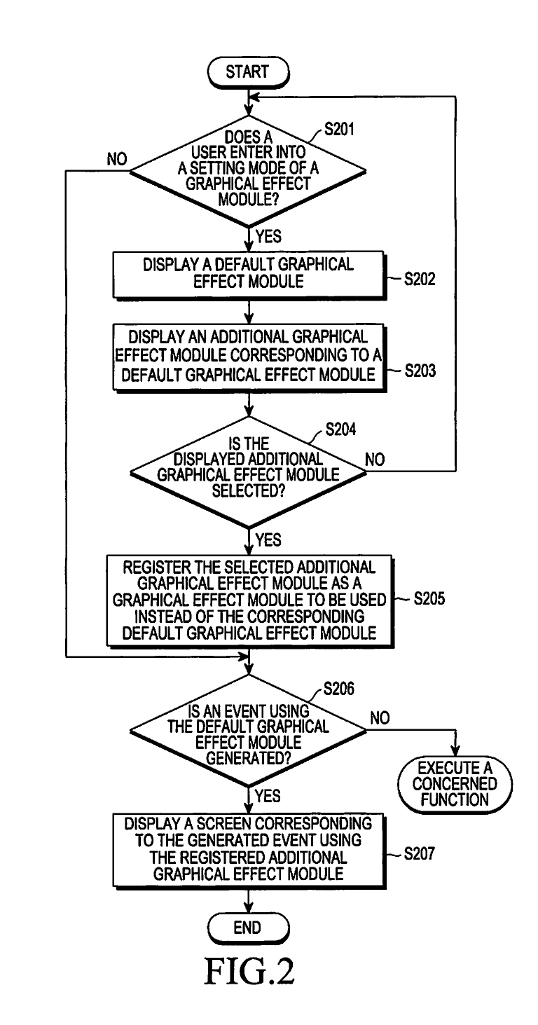

FIG. 2 is a flow chart illustrating a method for setting a graphical effect of a mobile terminal according to an embodiment of the present invention. Below, the embodiments of the present invention are explained in detail with referring to FIG. 1-FIG. 3.

Referring to FIG. 2, in steps S201 and S202, the control unit 10 determines whether a request for entry into a setting mode for a graphical effect module has been provided, and when the request for entry into the setting mode has been provided, the control unit 10 enters into the setting mode for controlling display of a default graphical effect module.

Referring to steps S201 and S202 based on FIG. 3, upon confirmation that a request for entry into a setting mode for a graphical effect module has been provided via a predetermined setting menu from a user, the control unit 10 enters into the setting mode. Subsequently, the control unit 10 controls display of the default graphical effect modules such as the graphical effect module 1 (31), the graphical effect module 2(32), the graphical effect module 3 (33) and the graphical effect module 4 (34) illustrated in FIG. 3.

The default graphical effect module is provided from a manufacturer of the mobile terminal or communication enterprises, in contrast to the graphical effect modules that are added by a user. When a predetermined event related to driving of a mobile terminal is generated, the term “default graphical effect module” refers a module including setting information related to a corresponding graphical effect module (i.e., a visual effect) to be displayed, data information, etc. Examples of a predetermined event related to driving of a mobile terminal include turning on/off the power of the mobile terminal, starting or stopping an application executed in the mobile terminal, and executing applications according to manipulation of the mobile terminal's.

In step S203, the control unit controls display of an additional graphical effect module corresponding to the default graphical effect module. In step S203, the control unit also determines whether the additional graphical effect modules (such as 31a-31b, 32a-32b, 33a-33b and 34a-34b) corresponding to the default graphical effect modules exist, as well as determining whether the default graphical effect modules 31-34 in illustrated in FIG. 3 exist. This determination process can be made by referring to an effect setting file included in graphical effect management unit 40.

Referring to FIG. 3, when the additional graphical effect modules corresponding to the default graphical effect module 1 (31) are identified as the graphical effect module 1-1 (31a) and the graphical effect module 1-2 (31b), the control unit 10 controls displaying these modules. Similarly, the control unit 10 controls display of the additional graphical effect modules 2-1 (32a) and 2-2 (32b) corresponding to the default graphical effect module 2 (32), display of the additional graphical effect modules 3-1 (33a) and 3-2 (33b) corresponding to the default graphical effect module 3 (33), and display of the additional graphical effect modules 4-1 (34a) and 4-2 (34b) corresponding to the default graphical effect module 4 (34).

However, if the graphical effect management unit 40 is included in the control unit 10, the effect setting file may be included in the control unit 10, but may be also included in the memory 30 separately.

Thereafter, at steps S204 and S205, the control unit 10 determines whether the displayed additional graphical effect module is selected by a user, and then controls a process for registering the selected additional graphical effect module as a graphical effect module to be used instead of a corresponding default graphical effect module.

Referring to steps S204 and S205 of FIG. 3, when a user selects the graphical effect module 1-1 (31a) indicated by the slanted lines, the control unit 10 controls a concerned setting process so that the additional graphical effect module, i.e., the graphical effect module 1-1 (31a) can be used instead of the default graphical effect module 1 (31).

In this way, when a user selects the graphical effect modules 2-2 (32b), 3-2 (33b), and 4-1 (34a) indicated by the slanted lines, the control unit 10 controls a concerned setting process so that the additional graphical effect modules 2-2 (32b), 3-2 (33b), and 4-1(34a) can be used instead of the graphical effect modules 2 (32), 3 (33), and 4 (34), respectively. Therefore, a user can separately set each graphical effect module (such as the selected additional graphical effect modules according to FIG. 3) to be used instead of each of the default graphical effect modules 31-34.

It is possible to create a setting for a specific additional graphical effect module to be used instead of the default graphical effect module, when the control unit 10 changes setting information (such as reference information) of the effect setting file, in order to refer to the additional graphical effect module that is set instead of the default graphical effect module. Before the setting information of the effect setting file is changed (e.g., when only default graphical effect modules exist), when an event that only the graphical effect module 1 (31) must be used is generated, the graphical effect module 1 (31) is referred to (via reference to the effect setting file) and then, the graphical effect is displayed. If the setting information of the effect setting file is changed by the control unit 10 such that the additional graphical effect module which is set instead of the default graphical effect module can be referred to, even if an event that corresponds to the default graphical effect module is generated, a graphical effect is displayed via the additional graphical effect module, which is set instead of the default graphical effect module.

As described above, according to embodiments of the present invention, a process for changing the graphical effect module can include changing only the effect setting file. Since it is not necessary to delete a default graphical effect module, such as graphical effect module 1 (31) in order to display a graphical effect via using an alternative graphical effect module, such as graphical effect module 1-1 (31a), embodiments of the present invention provide various advantages, such as removing the necessity for rebooting of a system (such as a mobile terminal) in order to apply setting changes for graphical effects. Further, changes can be made according to users' tastes without changing a structure of a mobile terminal.

At steps S206 and S207, the control unit 10 determines whether an event using the default graphical effect module is generated, and controls display of a screen in response to an event generated according to the additional graphical effect module registered at step S205 instead of the default graphical effect module.

Since the effect setting file is changed through steps S204 and S205, the control unit 10 controls display of a graphical effect via the graphical effect module 1-1 (31a) if an event using the graphical effect module 1 (31) is generated. Similarly, the control unit 10 controls display a graphical effect via the graphical effect module 2-2 (31b) if an event using the graphical effect module 2 (32) is generated, display of a graphical effect via the graphical effect module 3-2 (33b) if an event using the graphical effect module 3 (33) is generated, and display of a graphical effect via the graphical effect module 4-1 (34a) if an event using the graphical effect module 4 (34) is generated.

According to embodiments of the present invention, a user can set and use a desired graphical effect easily and conveniently, and therefore it may be possible to show a user the graphical effects set in an arbitrary timing/an event designated by an application, without restrictions related to the kinds of events and timing.

While embodiments of the present invention are shown and described herein, it will be understood by those skilled in the art that various changes in form and details may be made therein without departing from the spirit and scope of the invention as defined by the appended claims.

What is claimed is:

1. A method for setting a graphical effect of a mobile terminal, comprising:
displaying, when an entry for a setting mode of a graphical effect module is requested, a default graphical effect module;
determining whether at least one additional graphical effect module corresponding to the default graphical effect module exists;
displaying, upon a determination that the at least one additional graphical effect module corresponding to the default graphical effect module exists, the at least one additional graphical effect module; and
registering an additional graphical effect module selected from among the displayed additional graphical effect modules as a graphical effect module to be used instead of a corresponding default graphical effect module, according to a user-request.

2. The method of claim 1, further comprising displaying, when an event corresponding to the corresponding default graphical effect module is generated in a predetermined application, a graphical effect according to the registered additional graphical effect module.

3. The method of claim 1, wherein, in registering the selected additional graphical effect module, setting information of an effect setting file is changed so that the selected additional graphical effect module is used as a graphical effect module instead of the corresponding default graphical effect module, according to the user-request.

4. The method of claim 1, further comprising:
determining whether at least one additional graphical effect modules exists; and
outputting, upon a determination that additional graphical effect modules do not exist, a notification indicating an absence of additional graphical effect modules.

5. An apparatus for setting a graphical effect of a mobile terminal, comprising,
a memory for storing a default graphical effect module and at least one additional graphical effect module;
a control unit for displaying the default graphical effect module when an entry for a setting mode of a graphical effect module is requested, determining whether at least one additional graphical effect module corresponding to the default graphical effect module exists, displaying, upon a determination that at least one additional graphical module corresponding to the default graphical effect module exists, the at least one additional graphical effect module corresponding to the default graphical effect module, and registering an additional graphical effect module selected from among the displayed additional graphical effect modules as a graphical effect module to be used instead of the corresponding default graphical effect module according to a user-request; and
a display unit for displaying a graphical effect according to the default graphical effect module and the at least one additional graphical effect module corresponding to the default graphical effect module.

6. The apparatus of claim 5, wherein the control unit controls display of a graphical effect according to the registered additional graphical effect module when an event corresponding to the corresponding default graphical effect module is generated in a predetermined application.

7. The apparatus of claim 5, wherein, in registering the selected additional graphical effect module, setting information of an effect setting file is changed so that the selected additional graphical effect module is used as a graphical effect module instead of the corresponding default graphical effect modules, according to the user-request.

8. The apparatus of claim 5, wherein the control unit determines whether at least one additional graphical effect modules exists and outputs a user-notification indicating an absence of additional graphical effect modules upon a determination that additional graphical effect modules do not exist.

9. A recording medium which includes commands for enabling a mobile terminal to execute a method for setting a graphical effect and can be read by the mobile terminal, wherein the method comprises:
displaying, when an entry for a setting mode of a graphical effect module is requested, a default graphical effect module;
determining whether at least one additional graphical effect module corresponding to the default graphical effect module exists;
displaying, upon a determination that at least one additional graphical effect module corresponding to the default graphical effect module exists, the at least one additional graphical effect modules; and
registering an additional graphical effect module selected from among the displayed at least one additional graphical effect module as a graphical effect module to be used instead of a corresponding default graphical effect module, according to a user-request.

10. The recording medium of claim 9, wherein the method further comprises displaying, when an event corresponding to the corresponding default graphical effect module is generated in a predetermined application, a graphical effect according to the registered additional graphical effect module.

11. The recording medium of claim 9, wherein, in registering the selected additional graphical effect module, setting information of an effect setting file is changed so that the selected additional graphical effect module is used as a graphical effect module instead of the corresponding default graphical effect modules, according to the user-request.

12. The recording medium according to the claim 9, wherein the method further comprises:
determining whether at least one additional graphical effect module exists; and
outputting, upon a determination that additional graphical effect modules do not exist, a notification indicating an absence of additional graphical effect modules.
